(19) United States
(12) Patent Application Publication
(10) Pub. No.: US 2012/0205920 A1
(43) Pub. Date: Aug. 16, 2012

(54) AUTONOMOUS DOOR DEFENSE SYSTEM AND METHOD

(75) Inventors: Robert J. Gold, Jackson Heights, NY (US); Keith Kritselis, Austin, TX (US); Richard H. Wetnight, Surprise, AZ (US); Ko Hayashi, Las Vegas, NV (US)

(73) Assignee: CHANDLER PARTNERS INTERNATIONAL, LTD., Shanghai (CN)

(21) Appl. No.: 13/372,275

(22) Filed: Feb. 13, 2012

Related U.S. Application Data
(60) Provisional application No. 61/463,053, filed on Feb. 11, 2011.

(51) Int. Cl. E05C 1/02

(52) U.S. Cl. 292/138

(57) ABSTRACT

An autonomous door defense system for use with a door moveable between open and closed positions, wherein the door is secured within a doorway, includes at least one brace assembly selectively moveable between at least a defense position, wherein a portion of the brace assembly is positioned to substantially prevent the door from being moved into the open position, and a standby position. The system further includes an activation assembly configured to move the at least one brace assembly between the at least defense and standby positions.

### CROSS-REFERENCE TO RELATED APPLICATION

This application claims the benefit of U.S. Provisional Patent Application No. 61/463,053, filed Feb. 11, 2011, the disclosure of which is hereby expressly incorporated by reference herein.

### BACKGROUND

As the need for security access and egress proliferates, the problem exists of preventing unauthorized movement of personnel through doors of all types. This problem exists for most every type of location, including businesses, industrial locations, governmental buildings, military facilities, and especially homes. Intruders try to enter homes and business via the most basic pathway, which is usually the front or rear door. The intruders also try to enter using the simplest method, which is kicking open the door. This tactic is a favorite method in home invasion crimes, which are on the rise around the world, especially in many U.S. cities. The FBI reports that every 12 seconds, a home invasion occurs in the United States by an intruder, with as many as 73% of all break-ins going directly through the front door of a residence by kicking the door open. The failure of a door frame and a simple deadbolt lock are virtually always the cause of a failure to stop the intruder.

Kicking in a door is a fast entry technique that is also used in many burglaries, both in homes and business locations. Most doors are equipped with one or two locks that secure the door to the frame. With the hinges on the opposite side of the locks, this arrangement is usually a secure barrier to normal, non-invasive entry. However, when an intruder throws his or her weight against a door using his or her feet, the immense linear force of the amplified speed and weight of the intruder is often too much for the locks, even the hinges mounted within the door frame to withstand. The intruder may also use a mini sledgehammer to penetrate a “secured” residential front door, which can have the same effect as kicking in the door.

With the downturn in the economy, criminal activity is increasing, especially assaults against homeowners. While most burglaries occur between 9:00 AM and 5:00 PM, when most people are away from their homes, almost all home invasions occur between 6:00 PM and 6:00 AM when residents are home and relaxing or sleeping after a hard day at work. According to FBI uniform crime statistics, 38% of all assaults and 60% of all rapes occur during home invasion crimes. Door kicking is used as the primary method of entry because kicking the door open is a rapid and violent entry technique, and it can usually happen in as little as one second, leaving the victims defenseless with no time to even dial 911 for help.

If the home invasion crime could be delayed, homeowners would have time to call for help or would have time to prepare to defend their home with a firearm, which are in almost seventy percent (70%) of all U.S. homes. Thus, many home invasions could be stopped before they are even started.

Although there are a number of “anti-home invasion” devices on the market, their effectiveness is very low because of at least two factors: [1] people are complacent, and after a short time having such a device, the homeowners fail to put it in place or activate it at all times when they are home; and [2] most devices, when “on” the create the visual effect of making the home entry look like a prison or fortress, with bars or chains, and thus the homeowners are reluctant to place the devices in use on a regular basis.

Thus, there is a need for a reliable, cost-effective door defense system that is easy to use, that will prevent a door kick-in event, that can be retrofit onto existing doors and door frames while remaining aesthetically pleasing, that is autonomously activated when needed, and that does not impede the normal flow of traffic through a doorway.

### SUMMARY

An autonomous door defense system for use with a door moveable between open and closed positions, wherein the door is secured within a doorway, includes at least one brace assembly selectively moveable between at least a defense position, wherein a portion of the brace assembly is positioned to substantially prevent the door from being moved into the open position, and a standby position. The system further includes an activation assembly configured to move the at least one brace assembly between the at least defense and standby positions.

A method for autonomously securing a door in a closed position, wherein the door located within a doorway includes providing at least one brace assembly selectively moveable between at least a defense position, wherein a portion of the brace assembly is positioned to substantially prevent the door from being moved into the open position, and a standby position. The method further includes providing an activation assembly configured to move the at least one brace assembly between the at least defense and standby positions, providing a plurality of sensors configured to detect activity on an exterior of the doorway, and activating the activation assembly to move the at least one brace assembly into the defense position upon receipt of at least one signal from one of the plurality of sensors indicating activity detected.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the present disclosure will become more readily appreciated by reference to the following detailed description, when taken in conjunction with the accompanying drawings, wherein:

FIG. 1 is an isometric view of an exemplary embodiment of a door defense system of the present disclosure, wherein the door defense system is shown installed within a doorway assembly in a deployed defense mode;

FIG. 2 is an isometric view of a portion of the door defense system of FIG. 1, wherein the door defense system is shown in a retracted standby mode;

FIG. 3 is an isometric view of a portion of the door defense system of FIG. 2, wherein the door defense system is shown in a deployed defense mode;

FIG. 4A is an isometric view of a modular adjustable brace subassembly of the door defense system shown in a retracted standby mode;

FIG. 4B is a top planar view of the modular adjustable brace subassembly of FIG. 4A;

FIG. 5A is an isometric view of a modular adjustable brace subassembly of the door defense system shown in a deployed defense mode;

FIG. 5B is a top planar view of the modular adjustable brace subassembly of FIG. 5A;

FIG. 6 is a cross-sectional view of the modular adjustable brace subassembly of FIG. 4B, taken substantially across line 6-6;

FIG. 7 is a bottom isometric exploded view of the modular adjustable brace subassembly of FIG. 4A;

FIG. 8A is a partial isometric view of a portion of the door defense system of FIG. 2, wherein the door defense system is shown in a retracted standby mode;

FIG. 8B is a partial isometric view of a portion of the door defense system of FIG. 2, wherein the door defense system is shown being moved into a deployed defense mode;

FIG. 9 is a partial isometric view of a portion of the door defense system of FIG. 2, wherein the door defense system is shown being moved into a deployed defense mode;

FIG. 10 is a pictorial depiction of modules configured to control aspects of the door defense system and input sources in communication with the modules;

FIG. 11 is a graphical depiction of sensor systems for use with the door defense system;

FIG. 12 is an exemplary block diagram showing a sequence of operation of a portion of the door defense system; and

FIG. 13 is a schematic view of an impact sensor assembly for use with the door defense system of FIG. 1.

### DETAILED DESCRIPTION

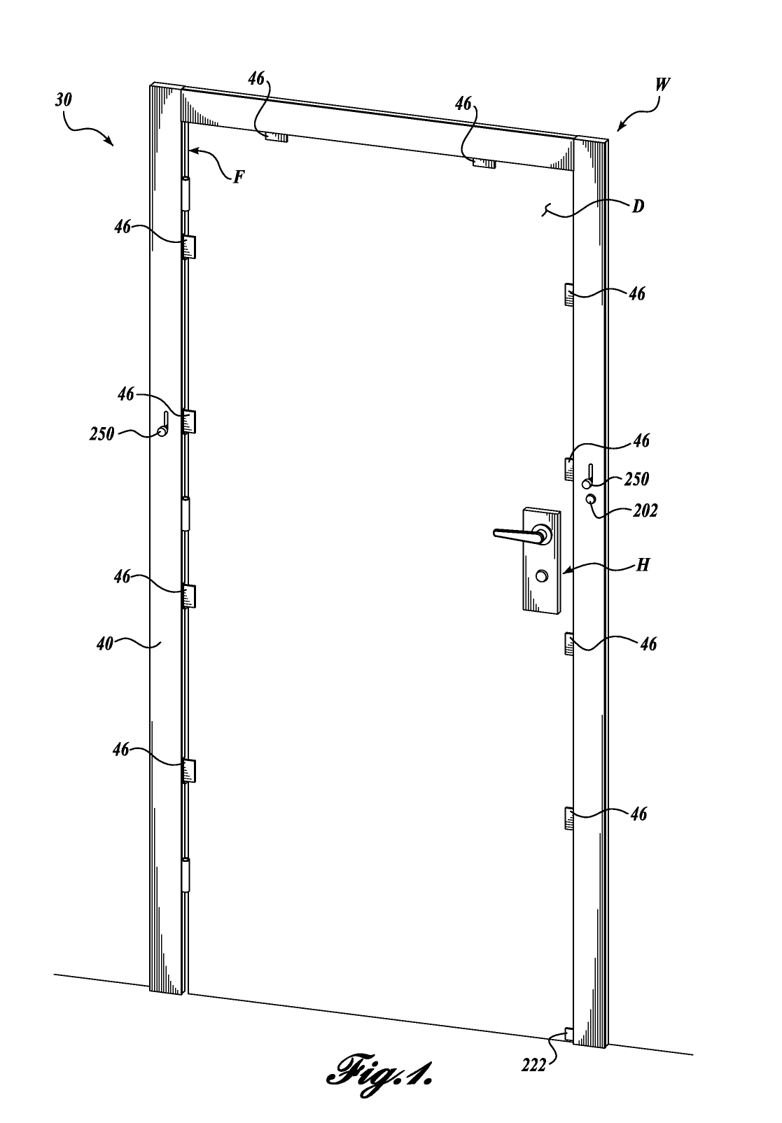

A door defense system 30 formed in accordance with an exemplary embodiment of the present disclosure may be understood by referring to FIG. 1. The door defense system 30 is generally configured to automatically and autonomously prevent a closed, locked or unlocked door from being open by force, such as by being kicked in, hit with a sledge hammer, etc. The door defense system 30 is shown in use with a doorway W having a door D hung within a doorframe F, wherein the door D may be selectively opened and closed by a door handle assembly H. However, it should be appreciated that the door defense system 30 may instead be used with any suitable opening having a door or similar device used to selectively open and close the opening. Thus, the descriptions and illustrations herein should not be seen as limiting the scope of the claimed subject matter.

Moreover, from time to time throughout the description, directional terms, such as upper, lower, top, bottom, vertical, horizontal, etc., may be used to describe aspects of the door defense system 30. It should be appreciated that such terms are for ease of description only, and should not be seen as limiting the scope of the present disclosure.

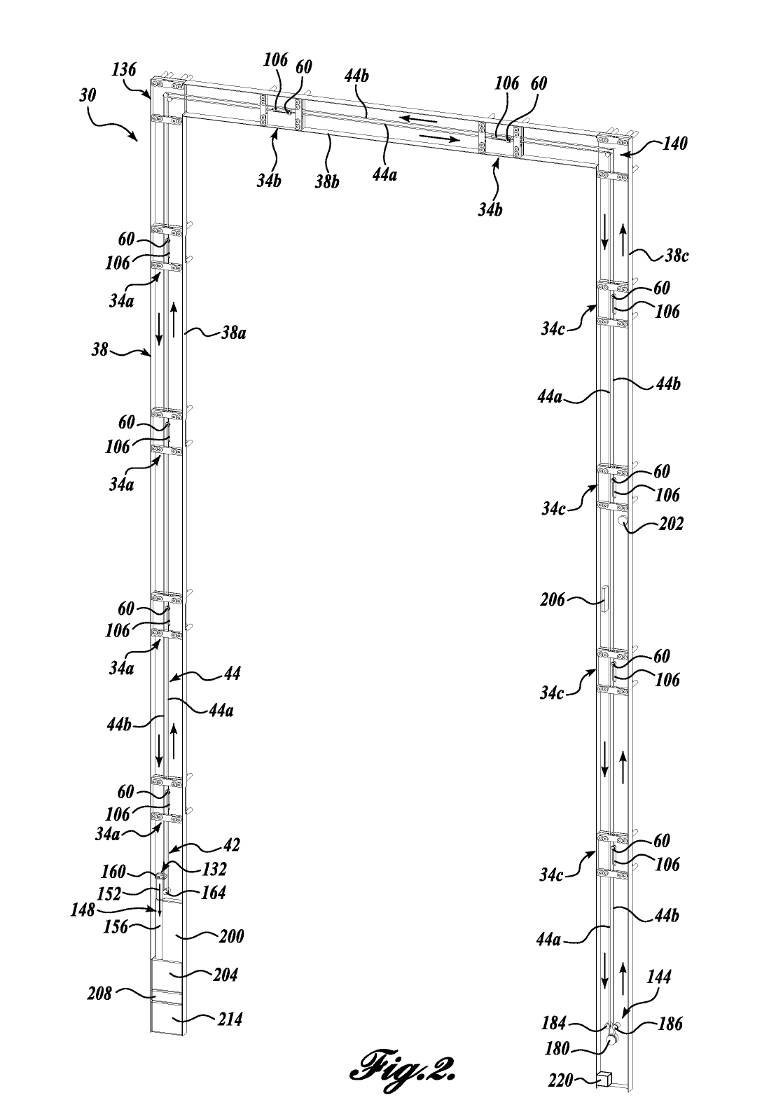

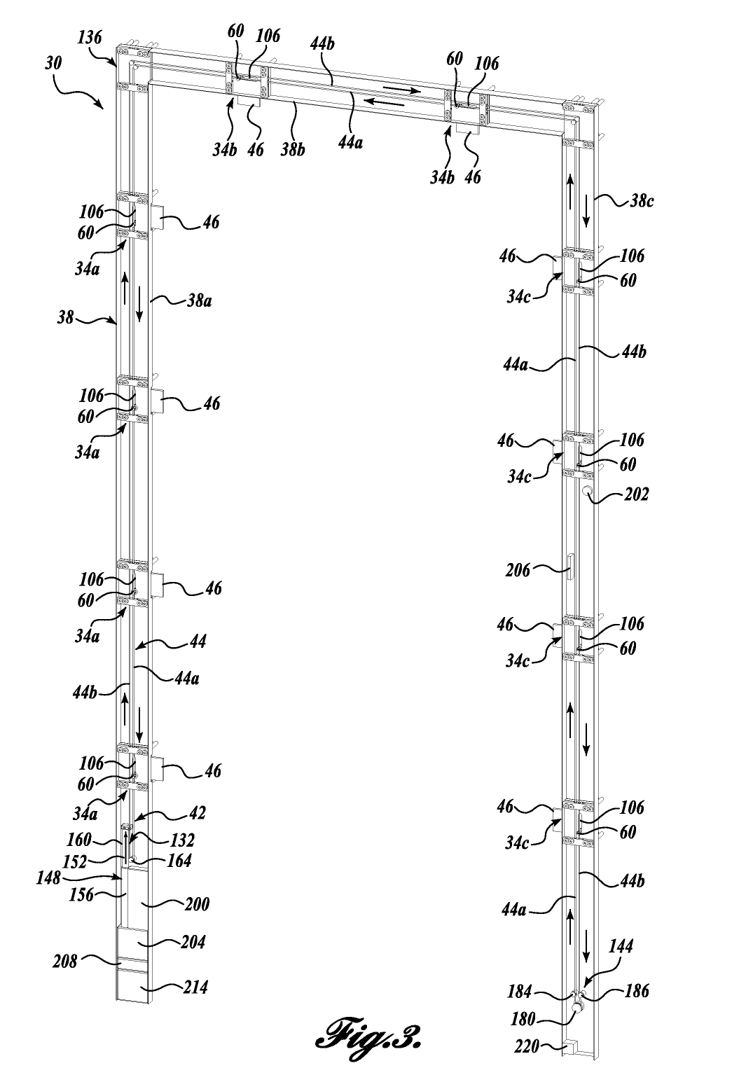

Referring additionally to FIGS. 2 and 3, the door defense system includes a plurality of modular, adjustable brace assemblies 34 (labeled as 34a, 34b, and 34c in FIGS. 2 and 3) secured within a channel of an interior frame 38 and enclosed by an exterior frame 40 (see FIG. 1). The interior and exterior frames 38 and 40 are formed in any suitable manner using any suitable materials. In the depicted embodiment, the interior and exterior frames 38 and 40, when secured together, look substantially similar to well known trim surrounding a doorway W. The interior and exterior frames 38 and 40 include suitable openings for receiving components of the door defense system 30 and for allowing components to move in and out of the frames 38 and 40 and between at least first and second positions.

The modular, adjustable brace assemblies 34 are in operable communication with a suitable activation assembly, such as a continuous loop-wire activation assembly 42 having a wire 44. Through the wire 44, the continuous loop-wire activation assembly 42 is configured to selectively move the modular, adjustable brace assemblies 34 between a deployed, defense mode (see FIGS. 1 and 3) to prevent a closed, locked or unlocked door from being open by force, and a retracted, standby mode (see FIG. 2) to allow the door to be opened and used in a normal manner.

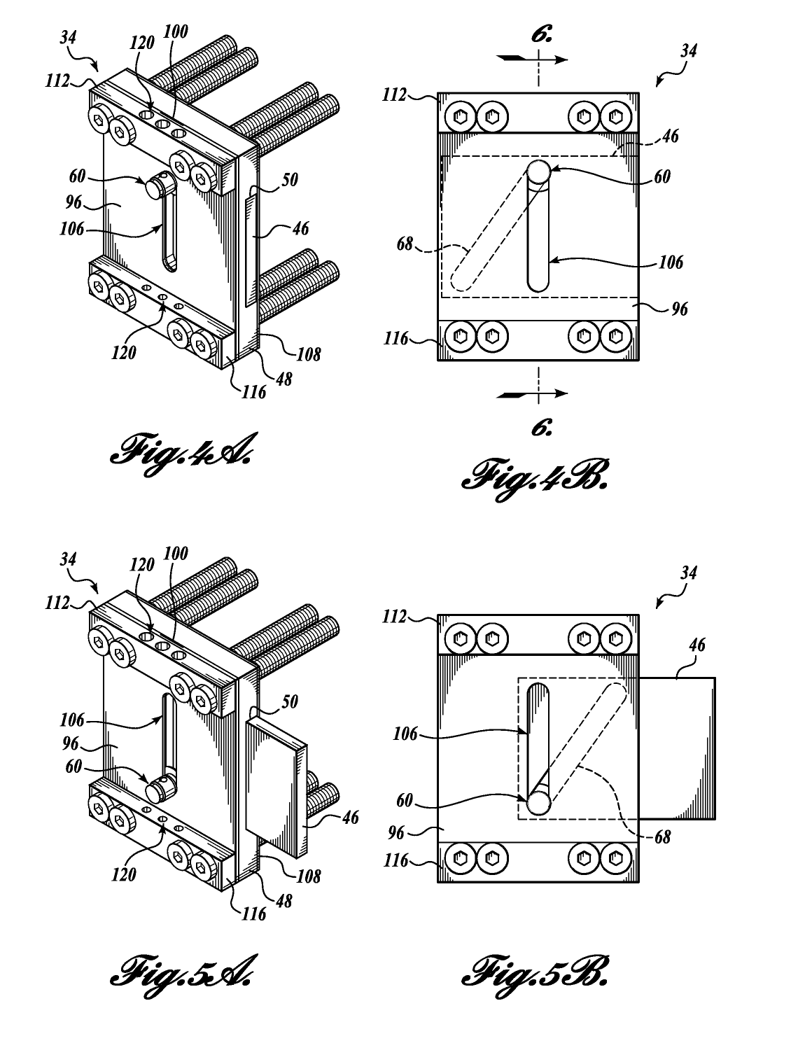

Referring to FIGS. 4A-4B, 5A-5B, 6, and 7, the modular, adjustable brace assemblies 34 will now be described in detail. The modular adjustable brace assemblies 34 each include a brace bar 46 slidably received within the body of the brace assembly 34. The body is defined in part by a brace body 48 having a brace bar slide path channel 50 sized and shaped to slidably receive the brace bar 46 therein.

The brace body 48 is of an overall suitable shape and size for securing the modular adjustable brace assembly 34 within a channel of the interior frame 38 that is substantially C-shaped in cross section, such as square. The brace bar slide path channel 50 extends substantially horizontally between lateral edges of the brace body 48 and is substantially centered within the brace body 48 to define upper and lower brace body portions 52 and 54 above and below the brace bar slide path channel 50.

The upper and lower brace body portions 52 and 54 include fastener openings (not labeled) that are configured to receive fasteners for securing the modular adjustable brace assembly 34 within the interior frame 38. Thus, with the brace body 48 secured within the channel of the interior frame 48, the brace bar 46 is slidably retained between the brace body 54 and the interior frame 48. In this manner, the brace bar 46 may be moved between the retracted, standby mode positioned within the interior frame 38 (see FIG. 2) and the deployed, defense mode positioned in front of the interior surface of the door D (see FIGS. 1 and 3).

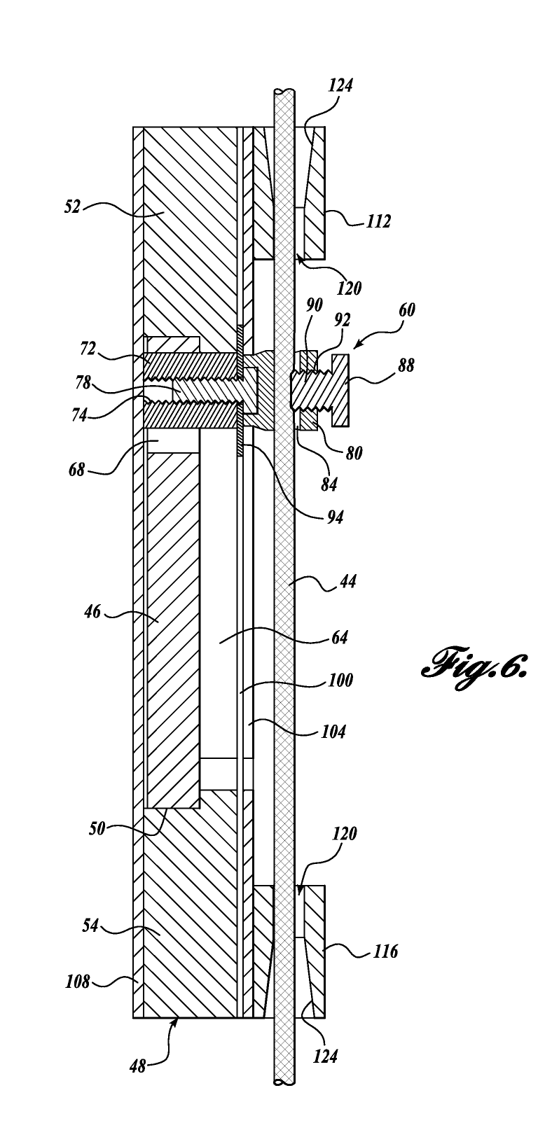

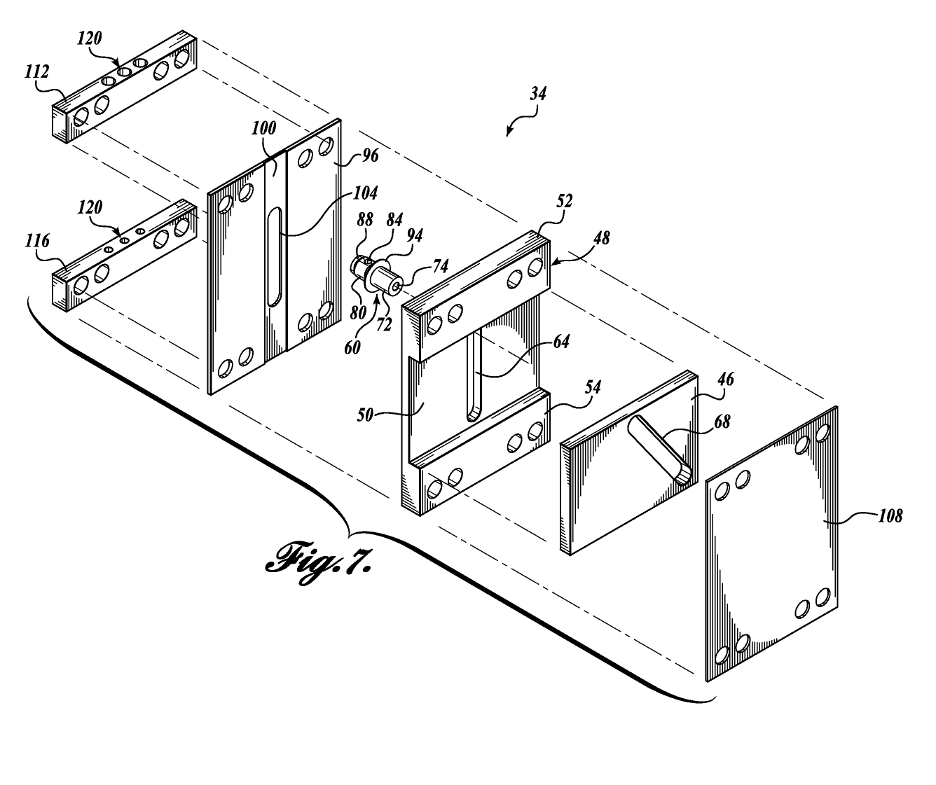

The brace bar 46 is moved between the retracted and deployed positions through a motion activation pin 60. The motion activation pin 60 is configured to travel vertically within a first motion slot 64 of the brace body 48 while causing horizontal motion of the brace bar 46 through movement within a diagonal motion activation slot 68 defined in the brace bar 46. As can be seen by referring to FIGS. 4B and 5B, the diagonal motion activation slot 68 is formed within a first half of the brace bar 46 such that movement of the pin 60 within the diagonal motion activation slot 68 causes the second half of the brace bar 46 to extend from or retract within the modular adjustable brace assembly 34.

Although the motion activation pin 60 maybe any suitable design, in the depicted embodiment, the motion activation pin 60 includes a motion contact sleeve 72 that is of a suitable length to extend through both the first motion slot 64 in the brace body 50 and the diagonal motion activation slot 68 in the brace bar 68. The motion contact sleeve 72 is also of a suitable shape, such as cylindrical, and it is sized to be slidably disposed within the first motion slot 64 and the diagonal motion activation slot 68. In that regard, the motion contact sleeve 72 may be formed from a suitable low friction material, such as a high lubricity plastic or Teflon, such that it may slide easily within the slots.

As can best be seen by referring to FIG. 6, the motion contact sleeve 72 includes a center through-hole 74 in substantial alignment with the longitudinal axis of the motion contact sleeve 72. The center through-hole 74 has internal threads for threadably receiving an elongated threaded member 78 extending from a wire capture body 80. The wire capture body 80, when secured to the motion contact sleeve 72 through the elongated threaded member 78, extends upwardly from the motion contact sleeve 72 to substantially define an extension thereof.

A wire opening 84 extends through the wire capture body 80 substantially transversely to the axis of the pin 60. The wire opening 84 is sized to receive an activation section of the wire 44 of the continuous loop-wire activation assembly 42 (either interior section 44a or exterior section 44b, depending on the location of the modular adjustable brace assembly 34). A cap 88 having a threaded stem 90 extending therefrom is secured within a threaded axial opening 92 extending from the top surface of the wire capture body 80. The threaded axial opening 90 intersects with and is substantially transverse to the wire opening 84. In this manner, torque can be applied to the cap 88 until the threaded stem 90 engages the wire 44 and tightly secures the wire 44 in its position within the wire capture body 80.

It can be appreciated that the position of the wire 44 within the wire capture body 80 (and thus relative to the modular adjustable brace assembly 34) can be readjusted as necessary by loosening and tightening the cap 88 on the wire 44. With the wire 44 secured within the wire capture body 80, movement of the wire 44 by the continuous loop-wire activation assembly 42 causes the motion activation pin 60 to move in the first motion slot 64 of the brace body 48. The pin 60 simultaneously moves in the diagonal motion activation slot 68 of the brace bar 46 to move the brace bar 46 between the retracted and deployed positions.

A slide ring 94 is disposed between the wire capture body 80 and the motion contact sleeve 72 to help guide the movement of the motion activation pin 60 within the slots. The slide ring 94 is shaped similarly to a well known washer, and it is formed from a suitable low friction material. The slide ring 94 is captured between the brace body 48 and a motion capture plate 96 secured to the brace body 48 to retain the motion activation pin 60 within the slots 64 and 68 as it moves.

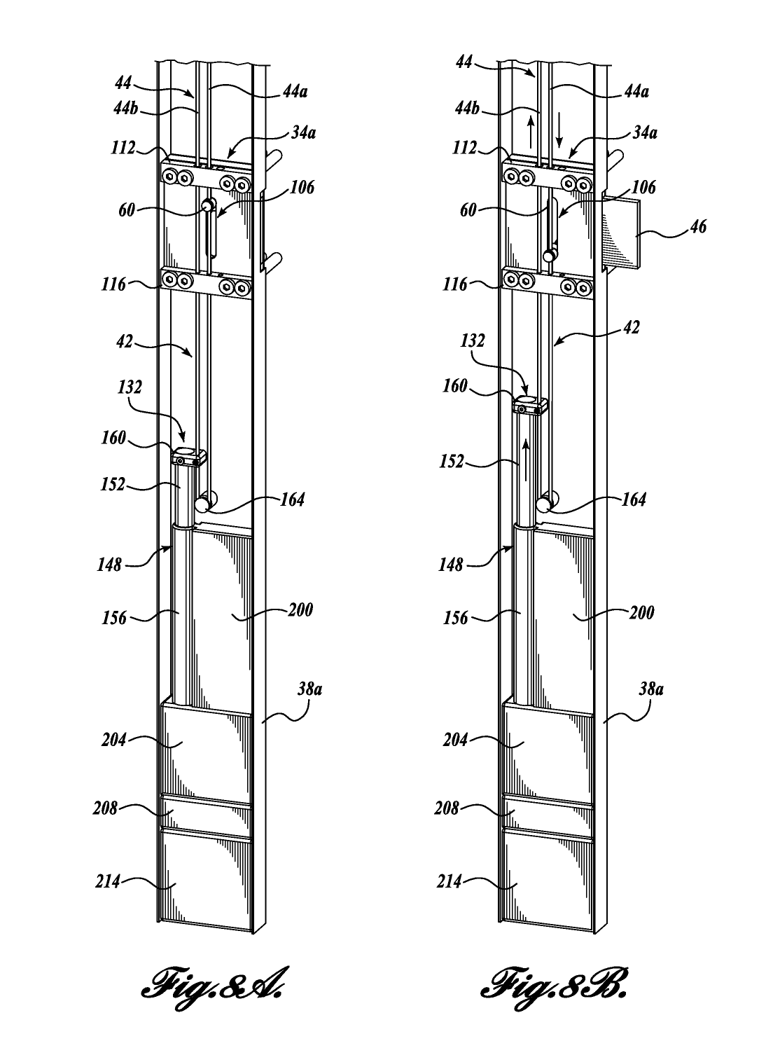

Referring to FIG. 7, the motion capture plate 96 is substantially the same size and shape as the brace body 48 and includes corresponding fastener holes (not labeled) for receiving fasteners. A slide ring channel 100 extends along the bottom surface of the motion capture plate 96 between its top and bottom edges. A second motion slot 104 is formed within the slide ring channel 100 and extends along a portion of the length of the channel 100.

The motion capture plate 96 is secured to the brace body 48 such that the first and second motion slots 64 and 104 are substantially aligned to collectively define a brace assembly slot 106. Fasteners may be passed through the fastener holes to secure the motion capture plate 96 to the brace body 48.

Prior to securing the motion capture plate 96 to the brace body 48, the motion activation pin 60 may be positioned relative to the motion capture plate 96. In particular, the motion contact sleeve 72 is positioned on the bottom side of the motion capture plate 96 with the slide ring 94 disposed within the slide ring channel 100 and with the threaded center through-hole 74 of the motion contact sleeve 72 aligned with the second motion slot 104. The wire capture body 80 is positioned on the top side of the motion capture plate 96 and the elongated threaded member 78 is passed through the second motion slot 104 and threaded within the center through-hole 74 of the motion contact sleeve 72.

The motion activation pin 60 may then be positioned within the brace body 48 and the brace bar 46. More specifically, the motion contact sleeve 72 is disposed within the first motion slot 64 of the brace body 48 and the diagonal motion activation slot 68 of the brace bar 46. The motion capture plate 96 may be thereafter secured to the brace body 48 by passing fasteners through the fastener holes. With the motion capture plate 96 secured to the brace body 48, the slide ring 94 is slidably retained within the slide ring channel 100 between the motion capture plate 96 and the brace body 48. As such, the motion contact sleeve 72 is slidably retained within the first motion slot 64 and the diagonal motion activation slot 68, and the wire capture body 80 is slidably retained within the second motion slot 104 (see FIG. 6).

It should be appreciated that the motion activation pin 60 may instead be secured relative to the motion capture plate 96 and the brace body 48 in any other suitable manner using any other suitable order of assembly steps. Thus, the foregoing description should not be seen as limiting the scope of the present disclosure.

With the motion activation pin 60 secured relative to the motion capture plate 96, the brace body 48, and the brace bar 46, the motion activation pin 60 may be thereafter secured to the wire 44 to place the modular adjustable brace assembly 34 in operable communication with the continuous loop-wire activation assembly 42, as shown in FIG. 3.

As noted above, the wire 44 of the continuous loop-wire activation assembly 42 is adjustably securable within the wire capture body 80 of the motion activation pin 60. The wire 44 may be secured within the wire capture body 80 of the motion activation pin 60 after the assembled brace bar 46, brace body 48, and motion capture plate 96 are disposed within the channel of the interior frame 38. In this manner, the position of the modular adjustable brace assembly 34 within the interior frame 38 may first be established.

Referring to FIG. 7, one or more warp adjustment plates 108 may be used to accommodate any warping in the door frame F or unevenness in the wall surrounding door D. The warp adjustment plate 108 is substantially the same size and shape as the brace body 48 and includes corresponding fastener holes (not labeled) for receiving fasteners. The warp adjustment plate 108 is positionable beneath the brace body 48 and securable thereto with fasteners. In this manner, the warp adjustment plate 108 slideably secures the brace bar 46 within the brace bar slide path channel 50 of the brace body 48 when secured to the brace body 48.

The warp adjustment plate 108 is of a predetermined thickness for adjusting the overall height (or depth) of the modular adjustable brace assembly 34 within the interior frame 38. The warp adjustment plate 108 is used if needed to position the brace bar 46 to slide in front of the interior door surface when the door D is closed, as shown in FIG. 1. It should be appreciated that multiple warp adjustment plates 108 may be used as needed to appropriately position the brace bar 46 to slide in front of the interior door surface when the door D is closed.

After the modular adjustable brace assembly 34 has been appropriately positioned within the interior frame 38, it may be placed into communication with the continuous loop-wire activation assembly 42 for transferring the movement of the wire 44 into the movement of the motion activation pin 60. To help facilitate the movement of the wire 44 within the interior frame 38, the modular brace assembly 34 may optionally include first and second wire guide bars 112 and 116.

Each wire guide bar 112 and 116 may be of a suitable shape and size to be secured to the upper and lower ends of the motion capture plate 96 above and below the second motion slot 104. A plurality of opposing, substantially aligned wire guide through-holes 120 are defined in each wire guide bar 112 and 116 having axes substantially parallel to the wire opening 84 in the motion activation pin 60. The wire guide through-holes 120 are configured to help guide the wire 44 of the continuous loop-wire activation assembly 42 as it moves throughout the system.

The wire guide through-holes 120 have an inner diameter slightly larger than the outer diameter of the wire 44 to help keep the wire 44 in a taught, substantially straight line while moving in the system. However, the outward facing ends of the wire guide through-holes 120 may include a frusto-conical shaped flared end portion 124 to soften the abrupt edge of the through-holes 120. In this manner, if the wire 44 extends between modular adjustable brace assembly 34 of different heights (or depths), the wire 44 will not scrape or wear against the edge of the wire guide through-holes 120 as it is pulled therethrough.

Each wire guide bar 112 and 116 includes fastener holes (not labeled) for receiving fasteners so that the wire guide bars 112 and 116 may be secured to the motion capture plate 96, brace body 48, and warp adjustment plate(s) 108 (if used) when the fasteners are passed therethrough. With the wire guide bars 112 and 116 secured to the modular adjustable brace assembly 34, interior and exterior wire portions 44a and 44b (see FIGS. 2 and 3) of the continuous loop of wire 44 may be fed through two of the three wire guide through-holes 120, depending on the location of the modular adjustable brace assembly 34 relative to the wire 44. The activation section of the wire 44 may then be secured within the wire capture body 80 of the motion activation pin 60. More specifically, the wire 44 may be passed through the wire opening 84, and the cap 88 may be secured within the wire capture body 80 to secure the wire 44 therein.

Referring specifically to FIGS. 4A-4B and 5A-5B, the manner in which the motion activation pin 60 (through the movement of the wire 44) moves the brace bar 46 between the retracted, standby mode (see FIGS. 4A-4B) and the deployed, defense mode (see FIGS. 5A-5B) will be hereinafter described.

Referring first to FIGS. 4A and 4B, the motion activation pin 60 is positioned at the upper end of the brace assembly slot 106 of the modular adjustable brace assembly 34. In this position, the motion activation pin 60 is also within the upper end of the motion activation slot 68 of the brace bar 46 and the brace bar 46 is in the retracted, standby position.

Referring to FIGS. 5A and 5B, as the motion activation pin 60 is moved downwardly within the brace assembly slot 106, the pin 60 must also travel downwardly within the motion activation slot 68 of the brace bar 46. The downward force of the motion activation pin 60 against the lower edge of the motion activation slot 68, causes outward, horizontal movement of the brace bar 46, moving the brace bar 46 into the deployed, defense position.

To move the brace bar 46 back into the retracted, standby position, the motion activation pin is moved upwardly within the brace assembly slot 106. As such, the pin 60 also travels upwardly against the upper edge of the motion activation slot 68. This causes inward horizontal movement of the brace bar 46, moving the brace bar 46 into the retracted, standby position.

Referring back to FIGS. 1-3, the manner in which the modular adjustable brace assemblies 34 are assembled within the interior frame 38 and operably connected to the continuous loop-wire activation assembly 42 will now be described. As noted above, the door defense system 30 includes a plurality of modular, adjustable brace assemblies 34 secured within a channel of an interior frame 38.

The interior frame 38 extends around the doorway W to frame the door D, similar to trim on a building interior or exterior doorway. In that regard, the interior frame 38 defines a hinge side frame portion 38a, a door handle side frame portion 38c, and a top side frame portion 38b extending between the upper ends of the hinge side frame portion 38a and the door handle side frame portion 38c. Depending on the size of the interior frame 38, one or more modular adjustable brace assemblies 34 are secured within the interior frame 38 at spaced locations around the frame. It should also be appreciated that only portions of the interior frame 38 may instead be used (with less modular adjustable brace assemblies 34) in a less expensive system. For instance, the door defense system 30 may instead include only an interior frame comprising a door handle side frame portion 38c, or a door handle side frame portion 38c and a top side frame portion 38b.

In the embodiment depicted in FIGS. 1-3, the door defense system 30 includes four hinge side modular adjustable brace assemblies 34a secured at spaced locations within the hinge side frame portion 38a, two top side modular adjustable brace assemblies 34b secured at spaced locations within the top side frame portion 38b, and four door handle side modular adjustable brace assemblies 34c secured at spaces locations within the door handle side frame portion 38c. It should be appreciated that any other suitable number and arrangement of modular adjustable brace assemblies 34 may instead be used.

The modular adjustable brace assemblies 34 are secured within the interior frame 38 such that the brace bar 46 of each brace assembly 34, when in the deployed, defense mode, is positioned adjacent to or near the interior surface of the door D. As such, the brace bars 46 are positioned to engage or stop the movement of the door D when it is opened by force or otherwise. In that regard, one or more warp adjustment plates 108 may be used when installing the modular adjustable brace assemblies 34 within the interior frame 38 to account for any warping or uneven surfaces around the doorway W. With the modular adjustable brace assemblies 34 installed within the interior frame 38, the modular adjustable brace assemblies 34 may be placed into communication with the continuous loop-wire activation assembly 42.

The continuous loop-wire activation assembly 42 includes a continuous loop of wire 44 that extends within the interior frame 38. The loop of wire 44 defines an interior wire portion 44a nearest the door D when installed, and an exterior wire portion 44b furthest from the door D when installed.

An activation section of the wire 44 is secured to the motion activation pin 60 of each modular adjustable brace assembly 34 in the manner described above. The activation section is defined by either the interior wire portion 44a, or the exterior wire portion 44b, whichever is connected to the motion activation pin 60 (depending on the location of the modular adjustable brace assembly 34 within the interior frame 38). The return section of the wire 44 is not connected to the motion activation pin 60 and moves in the opposite direction of the activation section of the wire 44.

The continuous loop of wire 44 extends from an actuator assembly 132 positioned within a bottom end of the hinge side frame portion 38a, up to a first corner angle module 136 positioned within an upper corner of the interior frame 38 between the hinge side frame portion 38a and the top side frame portion 38b, across to a second corner angle module 140 positioned within an upper corner of the interior frame 38 between the top side frame portion 38b and the door handle side frame portion 38c, and down to a return pulley assembly 136 positioned within a bottom end of the door handle side frame portion 38c. It should be noted that the position of the actuator assembly 132 and the return pulley assembly 144 can be switched without affecting the functionality of the door defense system 30.

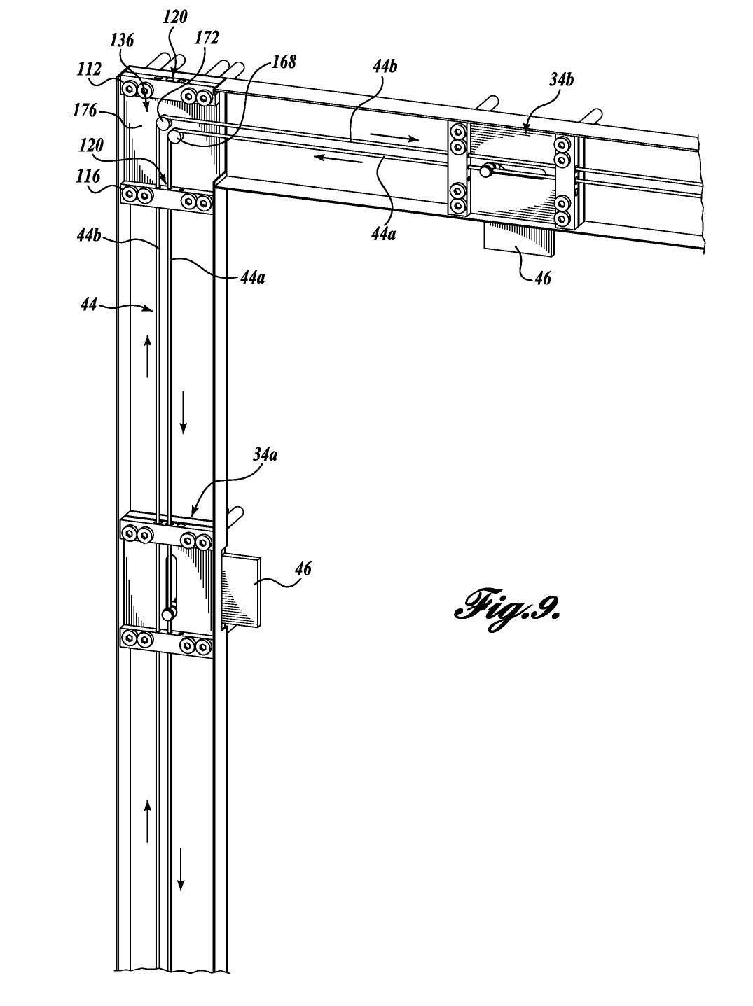

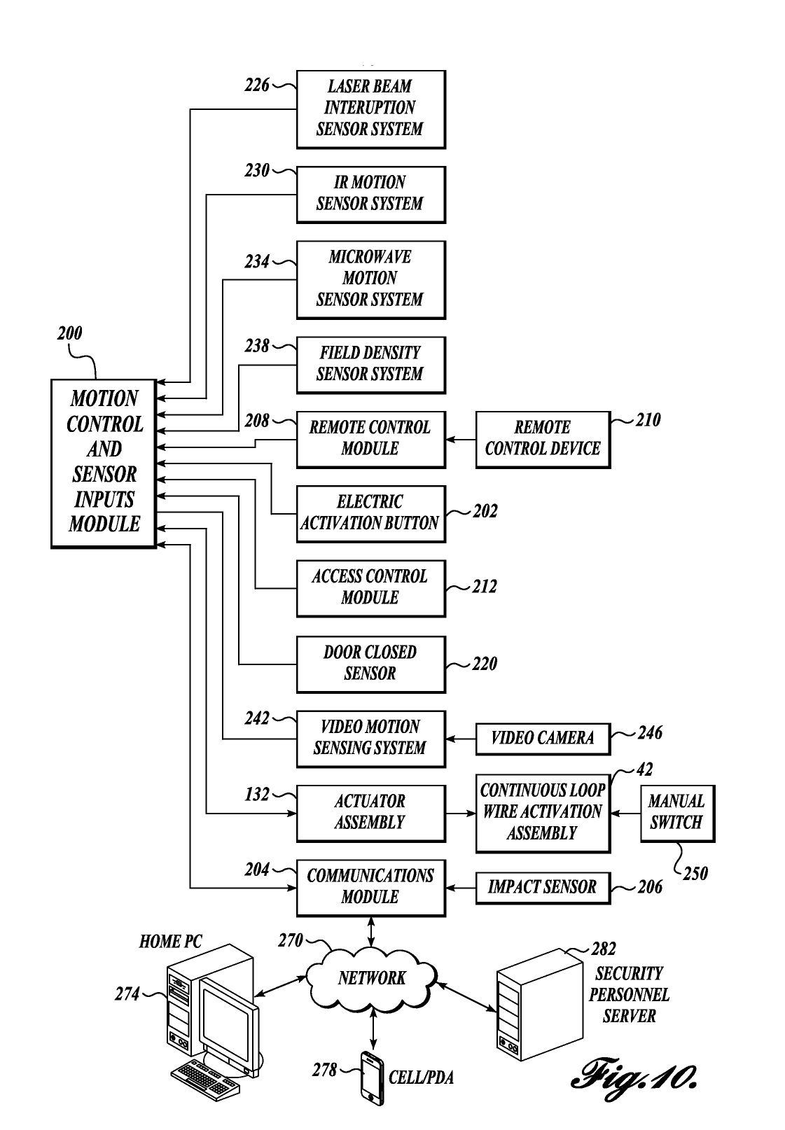

Referring to FIGS. 8A and 8B, the actuator assembly 132, which is suitable for moving the wire 44 to activate each modular adjustable brace assembly 34, will now be described in detail. The actuator assembly 132 includes a linear solenoid 148 having a solenoid piston 152 slidably disposed within and driven by a solenoid body 156. A connector block 160 is secured to the distal end of the solenoid piston 152 and therefore travels the same linear distance as the solenoid piston 152. The connector block 160 is also in linear alignment with and secured to the exterior wire portion 44b of the continuous loop of wire 44. In this manner, when the solenoid piston 152 is driven linearly in and out of the solenoid body 156, the continuous loop of wire 44 moves with the connector block 160 the same linear distance.

An actuator pulley 164 located near the solenoid piston 152 defines a first end of the continuous loop of wire 44 when the wire 44 loops around the actuator pulley 164. The actuator pulley 164 separates the exterior wire portion 44b from the interior wire portion 44a. In this regard, when the solenoid piston 152 drives the exterior wire portion 44b upwardly, the exterior wire portion 44b will pull the interior wire portion 44a downwardly around the actuator pulley 164, as shown in FIG. 8B, and vice versa. It should be appreciated that any suitable actuator assembly may instead be used to move the continuous loop of wire 44.

As noted above, the continuous loop of wire 44 extends from the actuator assembly 132 up to a first corner angle module 136 and then across to a second corner angle module 140. The first and second corner angle modules 136 and 140 are substantially identical; and therefore, only the first corner angle module 136 will be hereinafter described in detail.

Referring to FIG. 9, the first corner angle module 136 includes an inner corner pulley 168 configured to redirect the interior wire portion 44a toward the second corner angle module 140. In that regard, the second corner angle module 140 includes an inner corner pulley 168 that is substantially aligned with the inner corner pulley 168 of the first corner angle module 136. As such, the interior wire portion 44a extending between the first and second corner angle modules 136 and 140 is substantially transverse to the interior wire portion 44a extending between the first corner angle module 136 and the actuator assembly 132.

The first corner angle module 136 also includes an outer corner pulley 172 configured to redirect the exterior wire portion 44b toward the second corner angle module 140. Likewise, the second corner angle module 140 includes an outer corner pulley 172 that is substantially aligned with the outer corner pulley 172 of the first corner angle module 136.

The first corner angle module 136 may include first and second wire guide bars 112 and 116, as optionally used in the modular adjustable brace assemblies 34. The wire guide bars 112 and 116 may be used to guide the wire 44 into and out of the first corner angle module 136 and help maintain the alignment of the interior and exterior wire portions 44a and 44b with the modular adjustable brace assemblies 34.

The inner and outer corner pulleys 168 and 172 may be secured on a corner pulley plate 176, and the first corner angle module 136 may be assembled with one or more warp adjustment plates (not shown) to adjust the height, or depth, of the corner pulleys 168 and 172 and the openings 120 in the wire guide bars 112 and 116. It should be appreciated that the first corner angle module 136 may instead be constructed in any other suitable manner.

Referring to FIGS. 2 and 3, the continuous loop of wire 44 extends from the second corner angle module 140 down toward the return pulley assembly 144 at the bottom end of the door handle side frame portion 38c. The return pulley assembly 144 includes a return pulley 180 that defines a second end of the continuous loop of wire 44 when the wire 44 loops around the return pulley 180. The return pulley 180 separates the exterior wire portion 44b from the interior wire portion 44a. Inner and outer tension pulleys 184 and 186 may be disposed above the return pulley 180 on the outside of both the interior wire portion 44a and the exterior wire portion 44b for applying and maintaining tension in the wire 44.

The continuous loop of wire 44 is in operable communication with the modular adjustable brace assemblies 34 to selectively move the modular adjustable brace assemblies 34 between a deployed, defense mode (see FIG. 3) to prevent a closed, locked door from being open by force, and a retracted, standby mode (see FIG. 2) to allow the door to be opened and used in a normal manner.

As noted above, the depicted door defense system 30 includes four hinge side modular adjustable brace assemblies 34a secured at spaced locations within the hinge side frame portion 38a. The hinge side modular adjustable brace assemblies 34a are positioned within the hinge side frame portion 38a such that the brace bar 46 of each assembly 34a is positioned to extend to the right of the brace assembly 34a in front of the interior surface of the door D (see FIG. 1). The motion activation pin 60 of each assembly 34a is secured to the interior wire portion 44a of the continuous wire 44. As a result, the motion activation pin 60 is moved to the uppermost end of the brace assembly slot 106 when the brace bar 46 is in the retracted position (see FIG. 2), and the motion activation pin 60 is moved to the lowermost end of the brace assembly slot 106 when the brace bar 46 is in the deployed position (see FIG. 3).

The two top side modular adjustable brace assemblies 34b, secured at spaced locations within the top side frame portion 38b, are positioned within the top side frame portion 38b such that the brace bar 46 of each assembly 34b is positioned to extend down below the assembly 34b in front of the interior surface of the door D (see FIG. 1). The motion activation pin 60 of each assembly 34b is secured to the interior wire portion 44a of the continuous wire 44. As a result, the motion activation pin 60 is moved to the rightmost end of the brace assembly slot 106 when the brace bar 46 is in the retracted position (see FIG. 2), and the motion activation pin 60 is moved to the leftmost end of the brace assembly slot 106 when the brace bar 46 is in the deployed position (see FIG. 3).

Finally, the four door handle side modular adjustable brace assemblies 34c secured at spaced locations within the door handle side frame portion 38c are positioned within the door handle side modular adjustable brace assemblies 34c such that the brace bar 46 of each assembly 34c is positioned to extend to the left of the assembly 34c in front of the interior surface of the door D (see FIG. 1). The motion activation pin 60 is secured to the exterior wire portion 44b of the continuous wire 44. As a result, the motion activation pin 60 is located in the uppermost end of the brace assembly slot 106 when the brace bar 46 is in the retracted position (see FIG. 2), and the motion activation pin 60 is located in the lowermost end of the brace assembly slot 106 when the brace bar 46 is in the deployed position (see FIG. 3).

The modular adjustable brace assemblies 34a, 34b, and 34c are substantially identical, with the difference between the assemblies 34a, 34b, and 34c being defined by their location within the interior frame 38. More specifically, the top side modular adjustable brace assemblies 34b are rotated ninety degrees (90°) from the position of the hinge side modular adjustable brace assemblies 34a. Moreover, the door handle side modular adjustable brace assemblies 34c are rotated one hundred and eighty degrees (180°) from the position of the hinge side modular adjustable brace assemblies 34a, and the brace bar 46 is inverted before being assembled within the brace assembly 34a. In this manner, the brace bar 46 of each of the assemblies 34a, 34b, and 34c is positioned to extend in front of the interior surface of the door D, as shown in FIG. 1. In that regard, it can be appreciated that the design of the brace assemblies 34 are truly “modular” in nature in that the assemblies can be used anywhere within the interior frame 38 and rotated, reassembled, and/or repositioned as needed to ensure that the brace bar 46 can be moved into the deployed, defense position, as shown in FIG. 1.

Referring to FIG. 3, the brace bars 46 of each modular adjustable brace assemblies 34a, 34b, and 34c may be simultaneously moved between the retracted and deployed positions when the actuator assembly 32 selectively moves the continuous wire 44. When the solenoid piston 152 is driven out of the solenoid body 156, the exterior wire portion 44b within the hinge side frame portion 38a moves upwardly with the solenoid piston 152 (through the connector block 160). As a result, the interior wire portion 44a within the hinge side frame portion 38a moves downwardly. The downward movement of the interior wire portion 44a moves the motion activation pin 60 of the hinge side modular adjustable brace assemblies 34a into the lowermost end of the brace assembly slot 106, causing the brace bars 46 to move into the deployed, defense mode.

At the same time, the interior wire portion 44a within the top side modular adjustable brace assemblies 34b moves left. The leftward movement of the interior wire portion 44a moves the motion activation pin 60 of the top side modular adjustable brace assemblies 34b into the leftmost end of the brace assembly slot 106, causing the brace bars 46 to move into the deployed, defense mode.

Finally, the exterior wire portion 44b within the door handle side frame portion 38c moves downwardly. The downward movement of the exterior wire portion 44b moves the motion activation pin 60 of the door handle side modular adjustable brace assemblies 34c into the lowermost end of the brace assembly slot 106, causing the brace bars 46 to move into the deployed, defense mode.

To move the brace bars of each of the modular adjustable brace assemblies 34a, 34b, and 34c into the retracted, standby mode, the solenoid piston 152 is retracted within the solenoid body 156. The solenoid piston 152 moves the exterior wire portion 44b within the hinge side frame portion 38a downwardly through the connector block 160. As a result, the interior wire portion 44a within the hinge side frame portion 38a moves upwardly. The upward movement of the interior wire portion 44a moves the motion activation pin 60 of the hinge side modular adjustable brace assemblies 34a into the uppermost end of the brace assembly slot 106, causing the brace bars 46 to move into the retracted, standby mode.

At the same time, the interior wire portion 44a within the top side modular adjustable brace assemblies 34b moves right. The rightward movement of the interior wire portion 44a moves the motion activation pin 60 of the top side modular adjustable brace assemblies 34b into the rightmost end of the brace assembly slot 106, causing the brace bars 46 to move into the retracted, standby mode.

Finally, the exterior wire portion 44b within the door handle side frame portion 38c moves upwardly. The upward movement of the exterior wire portion 44b moves the motion activation pin 60 of the door handle side modular adjustable brace assemblies 34c into the uppermost end of the brace assembly slot 106, causing the brace bars 46 to move into the retracted, standby mode.

In the event that the actuator assembly 132 will not activate to move the continuous wire 44, the system may include one or more manual switches 250 that can move the brace bars 46 between the retracted and deployed positions. Referring to FIGS. 1 and 2, manual switches 250 may be defined by knobs secured on the end of motion activation pins 60. In particular, manual switches 250 are defined by a knob secured on the motion activation pin 60 of a hinge side modular adjustable brace assembly 34a, and of a door handle side modular adjustable brace assembly 34c. The manual switches 250 can be moved up to move the activation wire section up, thereby manually moving the brace bars 46 into the retracted positions. The manual switches can also be moved down to move the activation wire section down, thereby manually moving the brace bars 46 into the deployed positions.

It should be appreciated that in lieu of the continuous wire 44, individual actuator assemblies may be used to move the brace bars 46 of each modular adjustable brace assembly 34. Any suitable actuator assembly could be used, such as an assembly similar to the solenoid assembly 132 described above. It can be appreciated that with the use of an individual actuator assembly to move the brace bar 46, the modular adjustable brace assembly 34 may instead be designed without a motion activation pin 60. Rather, the actuator could directly move the brace bar 46 between the retracted and deployed positions. As a more specific example, if an assembly similar to the solenoid assembly 132 was used, the connector block 160 would be secured to the brace bar 46 so that the brace bar 46 moved the same linear distance as the piston 152 when it moved in and out of the piston body 156. Thus, it should be appreciated that the foregoing description and illustrations herein are exemplary only and should not be seen as limiting the scope of the claimed subject matter.

Referring to FIGS. 2 and 3, the actuator assembly 132 is in communication with a motion control and sensor inputs module 200 that is configured to control the automatic sequence of operations for the door defense system 30. The motion control and sensor inputs module 200 may include a suitable programmable logic controller (PLC) that receives digital input signals from one or more input sources defined within the door defense system 30. The PLC process the signals and activates or deactivates the actuator assembly 132 to move the brace bars 46 into a deployed, defense mode or a retracted, standby mode in response to the signals.

The input sources may include one or more electric activation buttons 202, one or more sensors located within the door defense system 30 for detecting various events, a remote control module 208 that receives and transmits various event data sensed from a remote control device 210, an access control module 212, and a communications module 204 that receives and transmits various event data sensed from an impact sensor 206.

It should be appreciated that the electrical components defining the input sources of the door defense system 30 are in communication with the motion control and sensor inputs module 200 through suitable wired or wireless means (not shown). Moreover, each component is powered by a suitable power supply. For instance, the components may be hard-wired into the surrounding building's electrical system through suitable electrical wiring. In the alternative, the components may draw power from the electrical system using a plug/outlet connection. In any event, the door defense system 30 may include a back-up battery and battery charger module 214 that may power one or more of the system components in the event of a power failure. Moreover, each component may also have an individual battery that powers the component in lieu of connection to a power supply or in the event of a power failure.

Referring to FIGS. 1-3, the electric activation button 202 may be located within the door handle side frame portion 38c of the interior frame 38 near the door handle H such that it is easily accessible. In the alternative, the door defense system 30 may include two electric activation buttons 202, one located on each side of the door D. The electric activation button 202 can be depressed into an ON state to activate the door defense system 30, causing the actuator assembly 132 to move the brace bars 46 into the deployed, defense mode (see FIGS. 1 and 3). The same or a separate electric activation button 202 can be depressed into an OFF state to deactivate the door defense system 30, causing the actuator assembly 132 to move the brace bars 46 into the retracted, standby mode (see FIG. 2).

The system may further include a door closed sensor 220 disposed within door handle side frame portion 38c of the interior frame 38. A sensor contact plate 222 is secured to the interior surface of the door D in alignment with the door closed sensor 220 when the door D is closed. Preferably, the door closed sensor 220 is disposed within the bottom or top of the door handle side frame portion 38c so that the sensor contact plate 222 may be secured on a discrete location on the door D, such as the bottom, as shown, or the top. The door closed sensor 220 senses whether the door is open (the sensor contact plate 222 is not aligned with the door closed sensor 220) or closed (the sensor contact plate 222 is aligned with the door closed sensor 220), and sends the appropriate signal to the motion control and sensor inputs module 200.

The PLC in the motion control and sensor inputs module 200 processes the signal from the door closed sensor 220 and keeps the door defense system 30 in standby mode if the door is open. In this manner, people can walk through the open, unobstructed doorway in a normal manner.

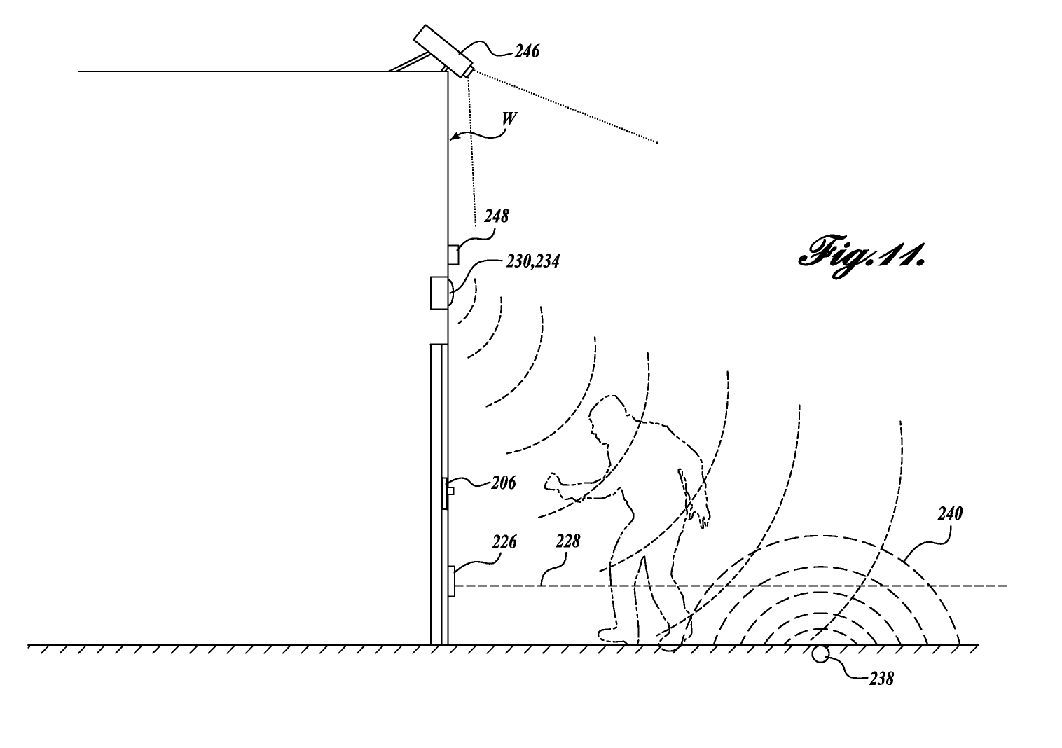

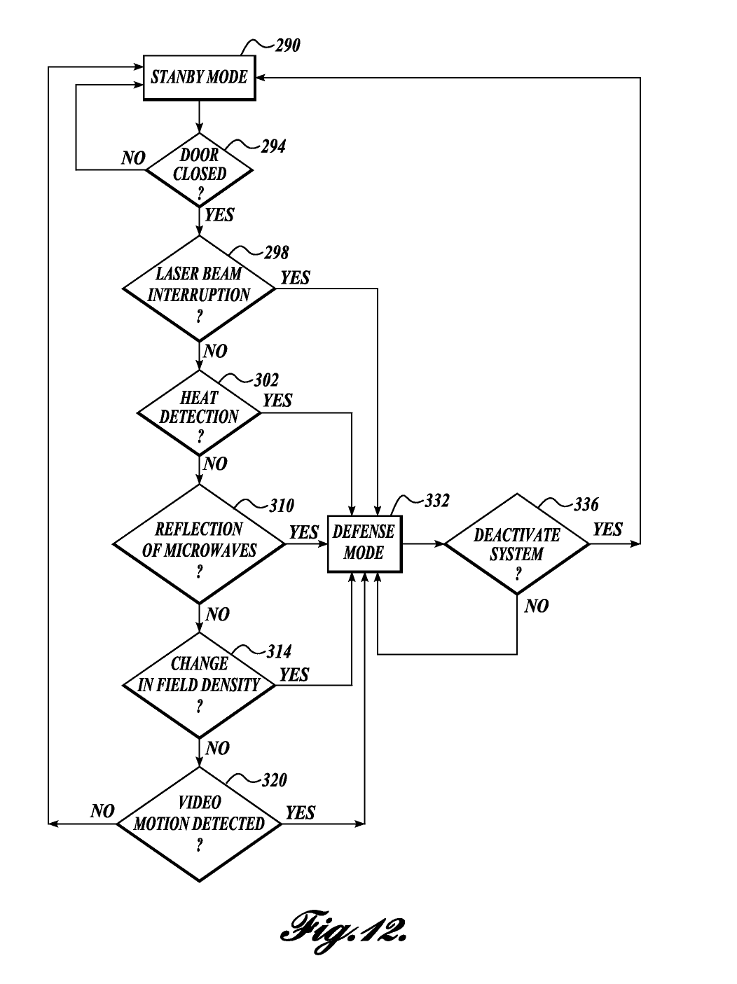

Referring to FIGS. 10 and 11, the door defense system 30 includes a plurality of sensors located in and around the doorway W for detecting a possible intruder before the intruder reaches the door D. Upon detection of the possible intruder, the sensors send a signal to the motion control and sensor inputs module 200, which processes the signal and possibly activates the door defense system 30.

Although the door defense system 30 may include any suitable arrangement and type of sensors, in the depicted embodiment, the system includes a laser beam interruption sensor system 226 that emits an invisible laser beam 228 and senses when an object interrupts the beam 228. The laser beam interruption sensor system 226 may be any suitable well known system that uses one or more reflectors to create an invisible fence with the beam(s) 228, which can be difficult to avoid when approaching the door D.

The system may further include an infrared (IR) motion sensor system 230 and a microwave motion sensor system 234, which can be combined into a single unit, to emit an IR/microwave sensor field. The IR/microwave sensor field can detect, for instance, the motion of an intruder's body by the detection of a heat and/or the reflection of microwaves.

The system may further include a field density sensor system 238 embodied as a cable buried beneath the ground's surface. The field density sensor system 238 emits a field effect sensor field 240. When a body passes through the field 240, it changes the density of the field and generates a signal, which the system 238 senses as the motion of a body passing through the field 240.

Finally, the system may further include a video motion sensing system 242 having a video camera 246. The video camera 246 may be mounted above the doorway W such that it is aimed toward the exterior of the door D. The field of view of the camera 246 is preferably large to detect changes as an intruder passes therethrough. Moreover, the video motion sensing system 242 may be programmed to eliminate false positive signals that can be caused by, for instance, small animals, wind-blown papers, blowing trees, etc.

As noted above, the sensors detect a possible intruder and send a signal to the motion control and sensor inputs module 200, which processes the signal and activates the door defense system 30 (i.e., moves the braces bars 46 into the deployed, defense mode) depending on certain criteria set forth in the PLC. For instance, the PLC may be programmed to activate the door defense system 30 if any of the sensors detect a possible intruder. In this manner, the door defense system 30 is activated before an intruder even gets to the door. The door defense system 30 may further include a microphone/speaker 248 for sounding an alarm or playing a pre-recorded message in an attempt to ward off the intruder.

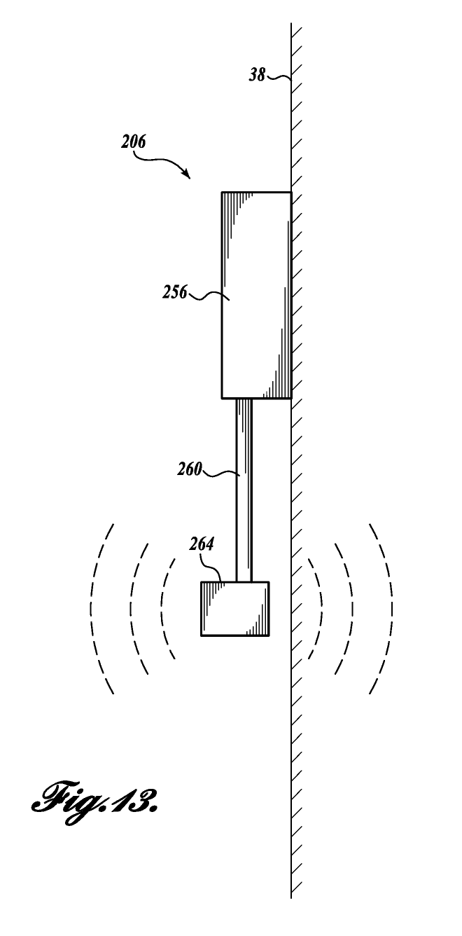

Referring to FIG. 12, an exemplary embodiment of a sequence of operation of a door defense system 30 having a motion control and sensor inputs module 200 and a plurality of sensors for detecting an intruder will be hereinafter described. First, the door defense system 30 is deactivated, or moved into standby mode, as indicated by block 290. With the door defense system 30 in standby mode, motion control and sensor inputs module 200 processes the signals from the door closed sensor 220 to determine if the door D is closed.

If the door D is closed, as indicated by decision block 294, the motion control and sensor inputs module 200 processes the signals from the laser beam interruption sensor system 226 to determine if the laser beam 228 was interrupted. If the laser beam 228 was interrupted (i.e., a possible intruder is detected), as indicated by decision block 298, the motion control and sensor inputs module 200 processes the signal and the system is activated into deployed, defense mode, as indicated by block 332. If the laser beam was not interrupted, the motion control and sensor inputs module 200 processes the signal and the system remains in standby mode, as indicated by block 290.

The motion control and sensor inputs module 200 similarly processes the signals from the IR motion sensor system 230 to determine if heat was detected, as indicated by decision block 302, from the microwave motion sensor system 234 to determine if the reflection of microwaves was detected, as indicated by decision block 310, from the field density sensor system 238 to determine if the density in the field has changed, as indicated by decision block 314, and from the video motion sensing system 242 to determine if video motion has been detected, as indicated by decision block 320. If none of the signals indicate that a possible intruder is approaching, the system remains in standby mode, as indicated by block 290. If one or more of the signals indicate that a possible intruder is approaching, the system is activated into deployed, defense mode, as indicated by block 332.

The system remains in defense mode until the system is deactivated, as indicated by decision block 336, either by activating the electric activation button 202, by using the remote control device 210, or by other suitable means.

As noted above, the motion control and sensor inputs module 200 is also in communication with a remote control module 208 having a remote control device 210. The remote control device 210 may be any suitable device that is in communication with the remote control module 208 through suitable wireless means. The remote control module 208 is configured to activate or deactivate the door defense system 30 in response to a signal received from the remote control device 210. Thus, a user can activate or deactivate the door defense system through the remote control device 210 in addition to the electrical activation button 202 and the manual switches 250.

The motion control and sensor inputs module 200 is also in communication with an access control module 212 that is configured to send a signal to the motion control and sensor inputs module 200 to activate or deactivate the door defense system 30. The access control module 212 may be embodied as an electrical key pad for entering a code, a biometric system (i.e. a finger print scanner, retina scanner, etc.), an electrical key switch that is activated by a key containing an RFID tag or other device, a card reader, or another suitable access control device now known or later developed. The access control module 212 may be located on the exterior of the doorway W such that an authorized person may activate the door defense system 30 upon leaving and deactivate the door defense system 30 to enter the home, office, building, etc.

Referring to FIGS. 10-12, the motion control and sensor inputs module 200 is also in communication with a communications module 204 that receives and transmits various event data sensed from an impact sensor 206. The impact sensor 206 may be positioned in a suitable location for sensing vibrations caused by an impact on the door D or nearby area. Referring additionally to FIGS. 2 and 3, the impact sensor 206 is located in the door handle side frame portion 38c near the door handle H of the door D when the door D is closed. In this manner, when an intruder attempts to kick in the door D near the door handle H (with an attempt to break open the lock), the impact sensor 206 will be nearest the impact. The impact sensor 206 is in communication with the communications module 204 through suitable wired or wireless means (not shown).

Although any suitable impact sensor 206 may be used, in the exemplary embodiment in FIG. 13, the impact sensor 206 includes a mounted printed circuit board (PCB) 256, a cantilevered flexible piezo wand 260 extending from the PCB 256, and a vibration mass 264 suspended on the free end of the cantilevered flexible piezo wand 260. The vibration induced in the doorway W causes the flexible piezo wand 260 to vibrate at specific frequencies. An electrical signal is generated by the flexing piezo crystal in the flexible piezo wand 260 corresponding to the vibration sensed in the impact sensor 206.

The impact sensor 206 sends a signal to the communications module 204 indicating the vibration sensed. For instance, the signal may indicate that only a normal knocking force was sensed. On the other hand, the signal may instead indicate that a hard knock or pounding force or even an extreme pounding force was sense. As yet another possibility, the signal may indicate that a door kick event was sensed. The communications module 204 processes the impact sensor signal to determine the level of impact sensed.

After processing the impact sensor signal, the communications module 204 may also communicate with one or more of a plurality of computers in a networking environment through a network 270. The network 270 may be implemented as a local area network (“LAN”), a wide area network (“WAN”), the global network commonly known as the Internet, or a cellular network. Although the communications module 204 may communicate with any suitable computer or device, in the depicted embodiment, the communications module 204 is in networked communication with a home personal computer (PC) 274, a cell phone/personal digital assistant (PDA) 278, and a security personnel server 282. The communications module 204 may also have the appropriate Universal Plug and Play (UPnP) networking protocols for detecting and communicating with onsite or remote alarm systems.

The communications module 204 may process the signal from the impact sensor 206, and depending on the type of signal processed, transmit data, a report, an alarm, etc., to one or more of the devices 274, 278, and 282. For instance, if the signal indicates that only a normal knocking force was sensed, the communications module 204 may send no data, report, alarm, etc., based on preprogrammed preferences. However, if the signal indicates that a door kick event was sensed, the communications module 204 may send a report and an alarm to both the home PC 274 and the cell phone/PDA 278. In addition, the communications module 204 may send a signal to the security personnel server 282 to alert a security company that a door kick event has occurred.

The communications module 204 may also send a signal to the motion control and sensor inputs module 200 to indicate the level of impact sensed. In this manner, if none of the sensors in communication with the motion control and sensor inputs module 200 (i.e., the laser beam interruption sensor system 226, the IR motion sensor system 230, the microwave motion sensor system 234, the field density sensor system 238, or the video motion sensing system 242) detect the intruder, the motion control and sensor inputs module 200 may process the signal from the communications module 204 and activate the door defense system 30.

It can be appreciated that the door defense system 30 may be employed in an environment having multiple doorways W under the control of a motion control and sensor inputs module 200. For instance, if the door defense system 30 was in use in a building that was on fire, the motion control and sensor inputs module 200 could be used to control which doors could open and close based on a determination of the safest and fastest exit from the building. As another example, to facilitate a search and clearing operation of a building, the motion control and sensor inputs module 200 could be used to lock down all the doors in the building. The doors could then be selectively opened for law enforcement personnel to search and designate a room “cleared.” Upon clearing the room, the doors could be re-locked through the door defense system 30 so that hostile entities cannot circle behind the law enforcement. Thus, it can be appreciated that the door defense system 30 has widespread application and many advantages.

While illustrative embodiments have been illustrated and described, it will be appreciated that various changes can be made therein without departing from the spirit and scope of the present disclosure.

The embodiments of the present disclosure in which an exclusive property or privilege is claimed as defined as follows:

1. An autonomous door defense system for use with a door moveable between open and closed positions, the door secured within a doorway, wherein the autonomous door defense system comprises:
(a) at least one brace assembly selectively moveable between at least a defense position, wherein a portion of the brace assembly is positioned to substantially prevent the door from being moved into the open position, and a standby position; and
(b) an activation assembly configured to move the at least one brace assembly between the at least defense and standby positions.

2. The system of claim 1, wherein the at least one brace assembly is positioned to engage an interior surface of the door in the defense position.

3. The system of claim 1, wherein the activation assembly includes a continuous loop of wire having an activation section and a return section.

4. The system of claim 3, wherein the activation assembly includes an actuator assembly in communication with the return section of the continuous loop of wire for moving the continuous loop of wire in first and second directions.

5. The system of claim 1, wherein the at least one brace assembly includes a brace bar that is moveable between the at least defense and standby positions.

6. The system of claim 1, further comprising a motion control and sensor inputs module configured to activate the activation assembly in response to signals received from one or more input sources.

7. The system of claim 6, further comprising a plurality of sensors in communication with the motion control and sensor inputs module, the sensors configured to detect activity on the exterior of the doorway and send at least a first signal to the motion control and sensor inputs module to indicate that activity is detected.

8. The system of claim 7, wherein the motion control and sensor inputs module is configured to activate the activation assembly to move the at least one brace assembly into the defense position upon receipt of at least one signal from one of the plurality of sensors indicating activity detected.

9. The system of claim 6, further comprising a communications module in communication with the motion control and sensor inputs module, the communications module in communication with an impact sensor located within the doorway.

10. The system of claim 9, wherein the impact sensor is configured to sense vibration within the doorway and send a signal to the communications module indicating the vibration sensed, and wherein the communications module is configured to process the signal to determine the level of impact sensed.

11. The system of claim 10, wherein the communications module is in networked communication with at least one computer, and wherein the communications module is configured to transmit at least one signal to the at least one computer based upon the processed signal received from the impact sensor.

12. A method for autonomously securing a door in a closed position, the door located within a doorway, the method comprising:
(a) providing at least one brace assembly selectively moveable between at least a defense position, wherein a portion of the brace assembly is positioned to substantially prevent the door from being moved into the open position, and a standby position;
(b) providing an activation assembly configured to move the at least one brace assembly between the at least defense and standby positions;
(c) providing a plurality of sensors configured to detect activity on an exterior of the doorway; and
(d) activating the activation assembly to move the at least one brace assembly into the defense position upon receipt of at least one signal from one of the plurality of sensors indicating activity detected.

13. The method of claim 12, wherein the at least one brace assembly is positioned to engage an interior surface of the door in the defense position.

14. The method of claim 12, wherein the plurality of sensors are selected from the group consisting of a laser beam interruption sensor system, an infrared motion sensor system, a microwave motion sensor system, a field density sensor system, a video motion sensing system, and any combination thereof.

15. The method of claim 12, further comprising providing a motion control and sensor inputs module configured to activate the activation assembly in response to signals received from one or more input sources.

16. The method of claim 15, wherein the plurality of sensors are in communication with the motion control and sensor inputs module and configured send at least a first signal to the motion control and sensor inputs module to indicate that activity is detected.

17. The method of claim 16, wherein the motion control and sensor inputs module is configured to activate the activation assembly to move the at least one brace assembly into the defense position upon receipt of at least one signal from one of the plurality of sensors indicating activity detected.

18. The method of claim 15, further comprising providing a communications module in communication with the motion control and sensor inputs module, the communications module in communication with an impact sensor located within the doorway.

19. The method of claim 18, wherein the impact sensor is configured to sense vibration within the doorway and send a signal to the communications module indicating the vibration sensed, and wherein the communications module is configured to process the signal to determine the level of impact sensed.

20. The method of claim 19, wherein the communications module is in networked communication with at least one computer, and wherein the communications module is configured to transmit at least one signal to the at least one computer based upon the processed signal received from the impact sensor.
